(19) United States
(12) Patent Application Publication
(10) Pub. No.: US 2014/0157282 A1
(43) Pub. Date: Jun. 5, 2014

(54) method for operating a real-time critical application on a control unit

(71) Applicants: Michael SCHLICK, Remseck (DE); Martin Vaupel, Vaihingen/Enz (DE); Jochen Haerdtlein, Kornwestheim (DE); Reihnard Gantenbein, Sersheim (DE); Bjoern Saballus, Stuttgart (DE)

(72) Inventors: Michael SCHLICK, Remseck (DE); Martin Vaupel, Vaihingen/Enz (DE); Jochen Haerdtlein, Kornwestheim (DE); Reihnard Gantenbein, Sersheim (DE); Bjoern Saballus, Stuttgart (DE)

(73) Assignee: Robert Bosch GmbH, Stuttgart (DE)

(21) Appl. No.: 14/094,030

(22) Filed: Dec. 2, 2013

(30) Foreign Application Priority Data
Dec. 4, 2012 (DE) 10 2012 222 215.4

(51) Int. Cl. G06F 9/50

(52) U.S. Cl. CPC G06F 9/5094
USPC 718/104

(57) ABSTRACT

A method for operating a real-time critical application, having at least two operating modes, on a control unit of a motor vehicle having at least two parallel processor cores or microprocessors, includes: reading out configuration data assigned to a selected operating mode from a memory assigned to the control unit, the configuration data having information concerning (i) the ability of task lists assigned to the selected operating mode to be executed on each of the at least two parallel processor cores or microprocessors, and/or (ii) the processor cores to be used for the operating mode selected; and determining, on the basis of the read configuration data, which of the at least two parallel processor cores or microprocessors is necessary to operate the real-time critical application and which is able to be switched off or operated in an energy-saving mode.

### BACKGROUND OF THE INVENTION

1. Field of the Invention

The present invention relates to a method for operating a real-time critical application on a control unit.

2. Description of the Related Art

In real-time critical applications such as engine management, an ABS application, an ESP application or perhaps a comfort and convenience application, for instance, control units are used having parallel processing units or processor cores. Two to three such parallel processor cores are customary today, and the assumption is for a greater number in the future for the purpose of engine management, for example. When working with such applications on parallel processor cores, it is necessary to distribute the respective task lists of the application software to the different processor cores. According to the present state of technological development, this distribution is predefined statically in fixed manner in the real-time area, reference being made here, for example, to the standardizations in the development partnership “AUTOSAR” (AUTomotive Open System ARchitecture). For example, prior to generating a binary code, the number of processor cores available and which task list(s) is/are to be executed constantly on which core are indicated. Such an assignment may no longer be changed afterwards, thus, during the running time.

The entire resource utilization is thereby determined statically prior to the actual start-up of the control unit. It is thus not possible to adapt the resource utilization to an instantaneous resource need, e.g., during different operating modes.

### BRIEF SUMMARY OF THE INVENTION

An object of the present invention is to permit the most efficient possible utilization of available processor cores on at least one multi-core processor in real-time critical applications.

According to the invention, it is now possible to distribute task lists dynamically to the processor cores available, as a function of the specific operating mode. Among other things, individual processor cores or multi-core processors may thereby be switched off or operated with reduced energy. Overall, therefore, a more efficient utilization of the existing resources is made available.

In this context, the term resources describes both individual processor cores as well as entire microprocessors (having one or more processor cores), memories and peripheral units such as CAN controllers, timer blocks or other IP blocks, for example. These resources are located either on one or on several microprocessors in the control unit. Resources in the control unit which are located outside of the microprocessor(s) are likewise included.

The present invention provides dynamic reconfigurability of the resource utilization of a real-time capable operating system and application software for control units having parallel processor cores or a plurality of microprocessors.

According to the invention, this reconfiguration may be carried out during operation, and especially in response to a change of operating mode.

According to the invention, configuration data is used which contains information as to which tasks or task lists may be performed on how many or which of the parallel processor cores or microprocessors provided. Additionally or alternatively, this configuration data may contain information as to which of the parallel processor cores or microprocessors provided are or are not necessary for a specific task list, and therefore may be switched on or off.

For example, in a specific operating mode, it is thereby possible to consolidate several task lists, e.g., task lists with lower computing demand, on fewer than the total number of processor cores or microprocessors available.

According to the invention, it is thus possible for certain operating modes, especially as a function of further parameters, for example, parameters concerning performance capability of the hardware of the control unit, e.g., environmental parameters such as temperature, atmospheric humidity and brightness, to switch off at least a portion of the processor cores or microprocessors provided, or at least to switch to an energy-saving mode. Altogether, therefore, a more efficient utilization of one or more microprocessors (having one or more processor cores), accompanied by energy savings, is attainable, thereby permitting a more ecologically-minded operation of the control unit.

The method of the present invention is carried out expediently in the case of a transition from one operating mode to another. To that end, upon each change of operating mode, it is advisable to import the configuration data (from a memory assigned to the control unit) for the new operating mode into the control unit. On the basis of the information obtained, possibly together with environmental parameters, the necessary or optimal number of processor cores or microprocessors to be used may then be calculated and switched on. Processor cores or microprocessors not required may be switched off or reconfigured. An initialization of the operating system for the parallel processor cores or microprocessors existing or used is subsequently carried out. After this step, the operating system is able to read in the task lists and configure further software layers such as RTE or IOC, for example, for the existing processor cores or microprocessors. This configuration is a function of the predefined distribution of the individual task lists to the individual processor cores or microprocessors.

The method of the present invention is carried out expediently upon each transition or switchover from one operating mode to another operating mode. In this way, the computer capacity available may constantly be adapted optimally to circumstances and demands.

After calculating and determining the processor cores needed, it is preferred that an operating system assigned to the control unit used for carrying out the method be started and then carry out a self-configuration on the basis of the processor cores or microprocessors determined.

In doing this, the operating system expediently activates task lists corresponding to the operating mode implemented or to be implemented in each case.

It is especially preferred that when calculating which of the parallel processor cores or microprocessors available are necessary to operate a real-time critical application, further parameters, particularly environmental parameters, are taken into account. For example, outside temperature, atmospheric humidity and performance capability of the control-unit hardware may be mentioned as parameters. Depending on the outside temperature, it may be advisable, for example, to switch certain electronic safety systems of a motor vehicle on or off. This means, for instance, that task lists assigned to an operating mode may be modified depending on parameters taken into account. For example, depending on the parameters considered, it is possible to refrain from the execution of individual tasks or even entire task lists.

A processing unit according to the present invention, e.g., a control unit of a motor vehicle, is set up, especially in terms of programming, to carry out a method of the present invention.

The implementation of the method in the form of software is also advantageous, since the costs entailed are particularly low, especially if an executing control unit is also used for further tasks and therefore is present in any case. Suitable data carriers for making the computer program available are, in particular, diskettes, hard drives, flash memories, EEPROMs, CD-ROMs, DVDs and many others. A program may also be downloaded via computer networks (Internet, intranet, etc.).

Further advantages and refinements of the present invention are yielded from the description and the accompanying drawing.

It shall be understood that the aforementioned features and the features yet to be explained below may be used not only in the combination indicated in each instance, but also in other combinations or by themselves, without departing from the scope of the present invention.

The present invention is represented schematically in the drawing based on an exemplary embodiment and is described in detail below with reference to the drawing.

### BRIEF DESCRIPTION OF THE DRAWING

FIG. 1 shows a flow chart together with a schematic representation of a flash memory of a control unit for the purpose of illustrating a preferred specific embodiment of the method according to the present invention.

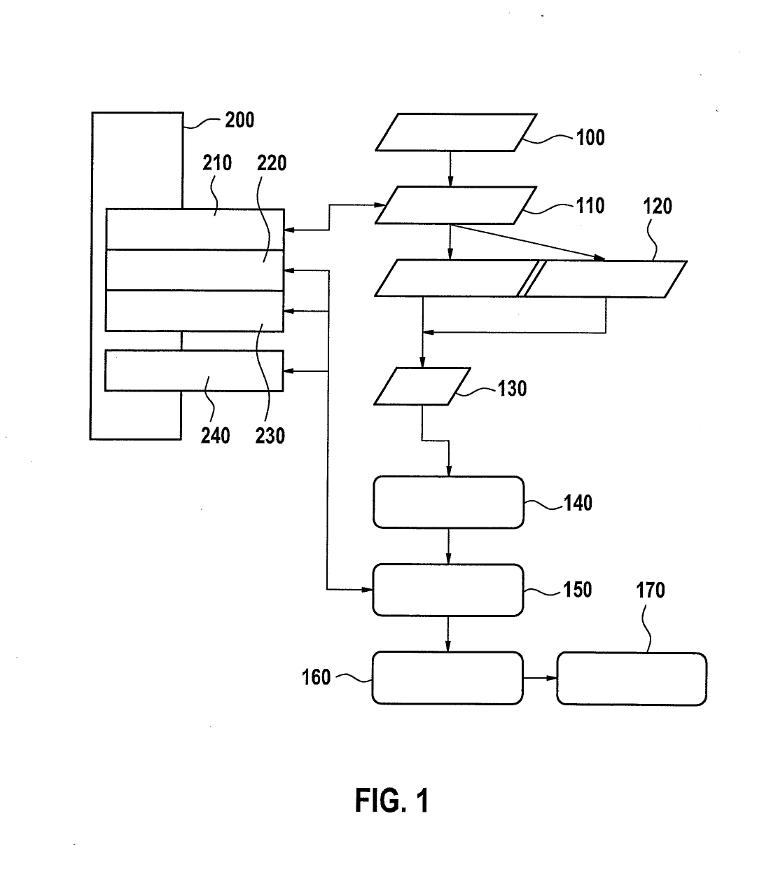

### DETAILED DESCRIPTION OF THE INVENTION

The control unit has at least two parallel processor cores or microprocessors (not shown).

In a step 100, in the case of the initiation of an operating mode or the switchover from a first to a second operating mode, possibly after a reset, a program start takes place.

In a subsequent step 110, vehicle configuration data 210 from a flash memory 200 assigned to the control unit is imported into the control unit. In so doing, instantaneous values for environmental parameters, e.g., temperature, atmospheric humidity and performance capability of the control-unit hardware may also be taken into account.

In a step 120, which of the at least two parallel processor cores or microprocessors provided are needed to operate the selected operating mode that represents a real-time critical application, and which processor cores or microprocessors may be switched off or operated in an energy-saving mode are calculated as a function of this configuration data 210.

In a following step 130, the operating system of the control unit is started on the basis of or using the processor cores or microprocessors identified in step 120. It is preferred that in a step 140, the operating system configure itself according to the number and the functionality, respectively, of the processor cores thus identified. For example, reference may be made here to the IOC (Inter OS-Application Communication), in which the communication between the processor cores identified is configured for the mode selected.

In a subsequent step 150, task lists 220, 230, 240 . . . assigned to the operating mode selected are read out from flash memory 200 and activated.

In a following step 160, further software layers, which are to be used according to the operating mode selected, are advantageously configured. Here, for example, reference may be made to RTE (Real-Time Environment). Subsequently, in a step 170, the application software represented by the task lists is run.

As illustrated, the configuration and activation in steps 140, 150, 160 and 170 are carried out on the basis of the processor cores selected in step 120.

What is claimed is:

1. A method for operating a real-time critical application, having at least two operating modes, on a control unit of a motor vehicle having at least two parallel processor cores or microprocessors, comprising:
reading out, from a memory assigned to the control unit, configuration data assigned to a selected operating mode of the at least two operating modes, wherein the configuration data include information concerning at least one of (i) the ability of task lists assigned to the selected operating mode to be executed on each of the at least two parallel processor cores or microprocessors, and (ii) which of the processor cores or microprocessors is to be used for the selected operating mode;
determining, on the basis of the read configuration data, which of the at least two parallel processor cores or microprocessors are necessary to operate the real-time critical application and which of the at least two parallel processor cores or microprocessors are one of able to be switched off or operated in an energy-saving mode; and
reading out and activating task lists assigned to the selected operating mode, from the memory assigned to the control unit.

2. The method as recited in claim 1, wherein the method is carried out upon each switchover from a first operating mode to a second operating mode.

3. The method as recited in claim 2, wherein:
after determining which of the processor cores or microprocessors are necessary to operate the real-time critical application, an operating system assigned to the control unit is started and carries out a self-configuration on the basis of the processor cores or microprocessors determined to be necessary to operate the real-time critical application.

4. The method as recited in claim 3, wherein the operating system activates the task lists corresponding to the selected operating mode implemented.

5. The method as recited in claim 3, wherein:
further parameters including environmental parameters are taken into account when determining which of the at least two parallel processor cores or microprocessors are necessary to operate the real-time critical application.

6. A non-transitory computer-readable data storage medium storing a computer program having program codes which, when executed on a computer, perform a method for operating a real-time critical application, having at least two operating modes, on a control unit of a motor vehicle having at least two parallel processor cores or microprocessors, the method comprising:
reading out, from a memory assigned to the control unit, configuration data assigned to a selected operating mode of the at least two operating modes, wherein the configuration data include information concerning at least one of (i) the ability of task lists assigned to the selected operating mode to be executed on each of the at least two parallel processor cores or microprocessors, and (ii) which of the processor cores or microprocessors is to be used for the selected operating mode;
determining, on the basis of the read configuration data, which of the at least two parallel processor cores or microprocessors are necessary to operate the real-time critical application and which of the at least two parallel processor cores or microprocessors are one of able to be switched off or operated in an energy-saving mode; and
reading out and activating task lists assigned to the selected operating mode, from the memory assigned to the control unit.
